(19) United States
(12) Patent Application Publication
(10) Pub. No.: US 2008/0305766 A1
(43) Pub. Date: Dec. 11, 2008

(54) Communication Device and Method for Setting a Security Configuration for a Communication Device

(76) Inventor: Rainer Falk, Poing (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/574,174

(22) PCT Filed: Oct. 4, 2004
(86) PCT No.: PCT/EP2004/052424

§ 371 Date: Aug. 22, 2008

(30) Foreign Application Priority Data
Oct. 2, 2003 (DE) 103 46 007.1

(51) Int. Cl. H04M 1/66; H04M 1/00

(52) U.S. Cl. 455/410; 455/556.2

(57) ABSTRACT

After a successful determination of an application environment for the communication device, a security configuration is selected from a number of stored security configurations and the communication device configured according to the selected security configuration.

### CROSS REFERENCE TO RELATED APPLICATIONS

This application is the US National Stage of International Application No. PCT/EP2004/052424, filed Oct. 4, 2004 and claims the benefit thereof. The International Application claims the benefits of German application No. 10346007.1 DE filed Oct. 2, 2003, both of the applications are incorporated by reference herein in their entirety.

### FIELD OF INVENTION

The invention creates a communication device as well as a method for setting a security configuration for a communication device.

### BACKGROUND OF INVENTION

Nowadays, provision is made for a fixed security configuration in a conventional communication device, said configuration being set in the communication device when the software is installed. More particularly, “Personal Firewall” communication devices, which are for example available from the companies Symantec/Norton, Sygate or ZoneLabs, have fixed security configurations.

A mobile communication device such as a personal digital assistant (Personal Digital Assistant, PDA) with one communication interface or a plurality of communication interfaces, which has been set up for wireless communication or for mobile radiocomunications, is or are usually used in a plurality of different application environments. It is desirable to guarantee the highest possible degree of communication security for the communication device, however, without unnecessarily restricting its ease of use.

[1] describes that a plurality of different security configurations is available in the communication device, and that a desired, selected security configuration for setting the communication device or the security-relevant parameters and/or the framework of the communication can be defined.

In accordance with [1], the specific security configuration, by means of which the communication device is operated, is selected depending on a called-up World Wide Web page, i.e. depending on whether or not a communication setup is accessed on the Internet, on a local Intranet, on a trustworthy Web page or a World Wide Web page with limited confidentiality, a different security configuration is selected in each case and as a result, the specific communication is operated with this selected security configuration.

Within the framework of the World Wide Web Browser Netscape Communicator™ program, settings, bookmarks and archived messages for the user concerned are stored in the personal profile of a specific user. A personal user profile makes it possible for a plurality of persons to be able to use the World Wide Web Browser Netscape Communicator™ with different configuration settings.

In this way, both the profile of a user and the configuration of the communication device are defined user-specifically.

[2] describes a method and a system in which provision is made for an access control, in which the authorizations for accessing the location of a user depending on whether or not the user is for example on the local Intranet or whether or not dial-in was implemented via a dial-up access.

In the case of the communication device in accordance with [3], the applications receive from a “Context Provider” information about the current context of the communication device for example about the geographical location of the communication device (referred to as “Master World” in this document) alternatively, based on the physical or logical units with a specific point of view (referred to as “Secondary World” in this document), for example to distinguish locations, buildings, floors and the offices of a company.

In addition, [4] describes a communication device in which a plurality of user interfaces have been defined and are activated depending on the location of the user or the communication devices. In accordance with [4] provision is made for the fact that, depending on a current location of the communication device, a World Wide Web Browser program in each case calls up different Start pages.

In addition, [5] describes a driver computer program for a communication device, in which a user profile for setting the communication network parameters, which are used within the framework of a communication can be set.

### SUMMARY OF INVENTION

Therefore, the invention is based on the problem of guaranteeing the highest possible degree or, if possible, an optimum degree of security of a communication by means of a communication device without creating any unnecessary user restrictions.

This problem is solved by a communication device as well as by a method for setting a security configuration of a communication device with the features in accordance with the independent patent claims.

A communication device has a device for determining an application environment, which has been set up for determining an application environment in which the communication device has been used. The application environment of the location can be seen clearly at the place where the communication device is located for setting up or re-establishing a communication connection.

In addition, the communication device has at least one communication interface, which has been set up for the communication with at least one other communication device in each case.

Furthermore, the communication device has a security configuration memory, in which a plurality of different security configurations with regard to the operation of the communication device has been stored.

Examples of different application environments are the company's own environment, a foreign company environment, the particular private residence, the private residence of a known third party or one of many different public access networks, for example, public access points.

The information defining the security measures given in the security configuration, which are to be guaranteed within the framework of the communication device, can basically contain any information, however, parameters are used in particular, for which provision is for example made in a “Personal Firewall”, which can restrict the communication depending on the communication partner, the used communication protocols, the services to be used or to be desired, the used computer programs or the time of day. In addition, information can also be stored in a security configuration, which defines non-security-relevant aspects for the communication devices.

In addition, the communication device has a device for determining a security configuration, which has been set up in such a way that by using the application environment determined, expressed in a different way, by using the application environment determined, a security configuration associated with this location or this application environment is determined from a number of security configurations. In addition, provision is made for a control device, referred to as a device for setting a security configuration below, which has been set up for setting the security configuration of the communication device in accordance with the security configuration determined by the device for determining a security configuration.

In a method for setting a security configuration for a communication device, an application environment for the communication device is determined in the first step in which the communication device is used. Expressed in a different way, this means that the application environment of the communication device is determined in the first step. From a number of different security configurations with regard to the operation of the communication device stored in a security configuration memory of the communication device, an associated security configuration is determined by using the application environment determined, which has been optimized with regard to the specifically determined application environment. If the associated security configuration has been determined, the communication device is set in accordance with the determined security configuration, i.e. configured. This means that after a successful configuration of the communication device with the security configuration determined, the communication device carries out a communication in accordance with the specifications in the given determined security configuration.

The invention can be seen clearly in that, depending on the current application environment, i.e. depending on the current application environment of the communication device, the security configuration belonging to the characteristics of the application environment is activated in the communication device, so that, within the framework of the communication of the communication device with another communication device at the specific location, the security configuration which is optimally adapted to the location is used.

This guarantees that, depending on the location, the maximum degree of security which is in actual required in the location concerned is guaranteed in each case and because of the adaptation of the security characteristics, the user restrictions are only handled as restrictively as absolutely necessary with reference to the required security in the specific application environment.

Preferred further developments of the inventions emerge from the dependent claims.

The following embodiments of the invention relate to the communication device and the method for setting a security configuration for a communication device.

The communication device is preferably set up as a mobile communication device, more particularly at least as one of the following communication devices:
a mobile radiotelephone,
a cordless telephone,
a Personal Digital Assistant (PDA),
a pager, or
a portable computer, for example, a notebook computer.

Naturally the individual communication devices or the individual functionalities and characteristics of the communication devices can be combined with each other in any way in a communication device.

In accordance with another development of the invention, provision is made for the fact that the communication interface has been set up
as a communication interface for the communication with a Personal Computer (PC),
as a modem communication interface,
as an ISDN adapter communication interface, and/or
as a LAN adapter communication interface.

In this case, the communication interface is usually a wired communication interface, i.e. a communication interface, which has been set up for wired communication with another device or with another communication device.

In the case, in which the communication interface has been set up for the communication with a Personal Computer, the communication interface is a serial communication interface or a parallel communication interface, or a USB communication interface. If the communication interface has been set up as a LAN adapter communication interface, this interface can for example be an adapter for a LAN connection, for example, for an Internet communication network or a Token Ring communication network.

As an alternative or in additionally, provision is made in accordance with another development of the invention for the communication interface or another communication interface, for which provision is additionally made in the communication device to be equipped as a radio communication interface in each case.

The communication interface is preferably set up as:
a wireless LAN communication interface,
a cordless communication interface, and/or
a mobile radio communication interface.

Should the communication interface be a wireless LAN communication interface, said interface could be set up in accordance with the communication standard 802.11, as a home RF communication interface, alternately as a Bluetooth communication interface.

A cordless communication interface is for example set up for communication in accordance with the DECT standard, the CT2 standard, the PHS standard or the PACS standard.

A communication interface which has been set up for example in accordance with the GSM standard, the GPRS standard, the UMTS-FDD standard, the UMTS-TDD standard, the CDMA standard, the AMPS standard, the DAMPS standard or the CDPD standards can be provided as a mobile radio communication interface.

In accordance with another development, provision is in addition made in the communication device for an allocation table memory, in which an allocation table has been stored. In the allocation table, at least one security configuration, which defines the communication security parameters optimized for the relevant application environment is allocated to an application environment in each case.

In this case, the security configuration for a corresponding determined application environment is determined by using the allocation table stored in the allocation table memory.

In accordance with another development, provision is made for the device for determining an application environment to have a device for recording an application environment which has been set up for the automatic recording and determining of the application environment of the communication device. The device for recording an application environment is preferably set up for recording one communication method or a plurality of communication methods used by the communication device and/or for recording one security mechanism or a plurality of security measures used by the communication device within the framework of a communication.

In this way, it is possible, in an extremely user-friendly way, without integrating the user of the communication device, in each case to use the optimally adapted and necessary security parameters, within the framework of the communication for the communication device.

However, as an alternative it is possible to present a user with a plurality of different application environments for selection purposes and, in addition, to use the resulting selection for determining the security configuration allocated to the selected application environment. In this case, the device for determining an application environment is for example a keyboard or another input medium for entering information into the communication device. For example, a number of application environments can be shown on a touchscreen to a user of a communication device and, in this case, the user only touches the touchscreen at the place where the desired application environment is shown, using a stylus or a finger. This input is identified and the desired application environment is determined in this way.

In accordance with another development of the invention provision is made for the device for recording an application environment to be set up for recording a security mechanism or a plurality of security mechanisms used by the communication device within the framework of a communication, in which case at least one of the following security mechanisms is taken into account:
an authentication method,
identification information for identifying a communication device or a subscriber, i.e. a user of the communication device,
a code exchange method for exchanging cryptographic codes, said method for example used for setting up a communication connection by means of the communication device,
a cryptographic code used within the framework of communication for the communication device, and/or
additional information elements used within the framework of the communication, for example, cryptographic codes based on certificates, tickets, credentials, etc.

The security mechanisms, in general the security measures, can in the same way as the mechanisms used above, be specific to a communication interface or a communication protocol to be used in accordance with the communication interface. However, they can also be implemented at higher communication protocol layers in accordance with a communication layer model, for example, in the case of a Windows network logon, a PPP authentication method (EAP variants, PAP, CHAP) or when logging in into a World Wide Web page.

The device for recording an application environment can be set up in such a way that at least one of the following application environments can be taken into account or provided by a user, in which case at least one security configuration is allocated to the specific application environment:
a company's own communication network,
a foreign communication network,
the home communication network of a user,
the home communication network of a third party,
the public communication network, and/or
an ad-hoc communication network.

In accordance with the developments of the inventions, information about at least one part of the following aspects can be contained in a security configuration:
Information about one communication protocol or a plurality of communication protocols, which can be used by the communication device,
Information about one target communication device or a plurality of the target communication devices, which can be reached by the communication device, for example target computers by means of which the communication device wants to set up a communication connection,
Information about computer programs or computer program functions, which can be run or called up from the communication device,
Information about security methods to be used by the communication device within the framework of the communication,
Information about data to be accessed by the communication device,
Information about the communication methods, which can be used at the same time by the communication device,
Information about the security methods permitted for the communication device,
Information about the security methods prohibited for the communication device and/or
Information about the security methods required for the communication device.

In particular methods for logging in to the network, protocols secured by cryptographic codes such as IPSec or SSL/TLS are suitable for use as security methods in each case.

A particular activation of a security configuration in the communication device can be kept in an event log, which can likewise be stored in a memory of the communication device. In other words this means that in accordance with this development of the invention, the specific setting of the change in the security operating parameters of the communication device is kept in accordance with the selected security configuration in an event log.

In addition, the activated, i.e. the determined security configuration can either be displayed to a user on an output unit of the communication device or on an external output unit in each case. In addition, it is possible, as explained above, for one application environment or a plurality of application environments determined or shown for selection purposes to be displayed to a user on an output unit of the communication device or an external output unit to which the communication device is connected. The output unit can be developed as a “normal” screen, for example, as a liquid-crystal display or also as a plasma display unit, in general as any electronic display unit on which data can be displayed to a user in each case.

The invention can be seen clearly as the communication device in accordance with the invention or the method according to the invention now making it possible to select and activate the security configuration of a communication unit or a communication device, which is adapted to an application environment. In this way, more particularly, from a security point of view, decisive advantages are obtained because different application environments require different protective measures than those as has already been explained in the above-mentioned. A particular home communication network or a company's own communication network represents a protected user environment, in which fewer protective measures are clearly acceptable than in a “hostile user environment”, as is for example represented by a public Internet access to a public communication network. In this case, the resulting problems, which are solved by the invention, will in future occur more intensified when portable communication devices, in particular those with wireless communication interfaces or mobile radio communication interfaces will be used increasingly in the different user environments.

In addition, the invention contributes towards the fact that protective measures such as a firewall are not rendered ineffective by mobile communication devices or communication units with a radio communication interface. In principle, a communication unit which is connected to a company-internal Intranet over a second, for example wireless communication interface or mobile radio communication interface could represent a communication network transition which is not secured and protected by an existing firewall. Such a communication interface can be deactivated by a security configuration adapted to a specific user environment in accordance with which the specific communication device is operated. In this way, the degree of the available security is optimized.

### BRIEF DESCRIPTION OF THE DRAWINGS

Examplary embodiments of the invention are shown in the figures and explained in greater detail below.

The Figures show

FIG. 1 a sketch of a communication device in accordance with a first embodiment of the invention;

FIG. 2 a flowchart in which the individual steps of a method are shown in accordance with an embodiment of the invention;

FIG. 3 a sketch of a communication device in accordance with a second embodiment of the invention.

### DETAILED DESCRIPTION OF INVENTION

FIG. 1 shows a personal digital assistant (PDA) 100 as the communication device.

PDA 100 has an antenna as well as one communication interface or a plurality of communication interfaces, which is/are developed as a wired communication interface or a wireless communication interface (not shown).

In this case, PDA 100 preferably has at least one of the following communication interfaces:
a radio module for a Wireless-LAN (for example in accordance with the 802.11 standard or in accordance with HomeRF),
a radio module for cordless communication (for example in accordance with the DECT standard, the CT2 standard, the PHS standard or the PACS standard);
a radio module for the mobile radiocommunications (for example in accordance with the GSM standard, the GPRS standard, the UMTS-FDD standard, the UMTS-TDD standard, the CDMA-standard, the AMPS standard, the DAMPS standard and the CDPD standard);
an interface for direct communication with a PC, set up as a serial interface and/or as a parallel interface, for example as a USB interface;
a modem communication interface;
an ISDN adapter communication interface; and/or an adapter for a LAN connection, for example, for an Internet communication network or a token ring communication network.

In addition, the PDA 100 has keys for the input of information, which are not shown here and as an alternative or in addition a touchscreen, i.e. a touch-sensitive display unit for the output and input of information by a user and/or an interface for a connection to a power supply network.

In addition, provision is made for control keys in order to control the behavior of the PDA 100.

In addition, the PDA 100 has a configuration unit, preferably set up as a microprocessor, by means of the communication parameters, more particularly security-relevant communication parameters of the PDA 100 are determined.

By means of the security-relevant communication parameters, it is determined in each case how communication is to be executed by means of the PDA 100, more particularly which security aspects and security measures have to be taken into account and guaranteed. The specific security aspects and security measures are explained in greater detail below.

In addition, provision is made for a plurality of memories in the configuration unit 101 in which case the plurality of memories can also be implemented as a common memory, in which the memory has special memory areas for the different data, which has to be stored in each case.

In a first memory 102 or in a first memory area 102, a current application environment, which is explained in greater detail below, i.e. the current location of the PDA 100, is stored.

In addition, an allocation table 103 is stored in a second memory or in a second memory area, by means of which at least one security configuration, which is explained in even greater detail below, is stored for a specifically given application environment.

A computer program is stored in a third memory or in a third memory area, said program being set up in such a way that it can set up the security-relevant communication parameters of the PDA 100 for setting the communication parameters to be used within the framework of a communication which is explained in even greater detail below.

In addition, the security configurations 105, 106, 107 are stored in a fourth memory or in a fourth memory area n (n=1, 2, . . . , m, in which m gives the maximum number of stored security configurations).

In accordance with the first embodiment of the invention, the PDA 100 has been set up in such a way that its current application environment, i.e. its current location can be determined automatically. As a result, this is carried out in accordance with this embodiment in that, within the framework of a communication the currently used communication method in each case or the communication protocols and the security measures to be used in each case, which a communication partner would like to use within the framework of a communication connection setup, are recorded and identified.

As the identification features the network communication interface used in each case, in accordance with the embodiment of the invention, the communication logon method used in each case, the communication setup or the authentication method used in each case for the logon of a communication connection and thus the cryptographic codes used in this case, identification information or identification information, by means of which the identity of a network access point (Access Point) or a operating company identification and/or used security methods such as for example the setup of a VPN communication connection (Virtual Private Network) to a network access server computer and thus the used parameters (identification information, cryptographic code, authentication method) are used in this case. An application environment can also be determined by the location of the communications unit, which is determined by using a service as described in [3]. As an alternative, such a location (as described in [3] provided by a service) can show an identification feature, which is evaluated together with the additional identification features in order to determine the current application environment in each case.

For example, in the case of a Wireless LAN communication interface it is possible to communicate within a company's own communication network, in a Wireless LAN communication network of another company, in a public Internet access, for example, at an airport, in a hotel or also in a conference, or in a home communication network of a user of the PDA or in a home communication network of another person.

If in addition, provision has been made for a communication interface in the PDA 100 for a direct communication connection to a Personal Computer in order for example by using it to synchronize the database of the PDA 100 with the database stored in a Personal Computer, access to a computer communication network is naturally made possible in this case.

In the above-described embodiments of the invention, four application environments are taken into account, which are stored in the allocation table 103 and to which in each case a security configuration has been allocated which is explained in greater detail below.

The embodiments take into account the following four application environments;
Wireless LAN application environment within a company's own communication network;
Wired communication interface to a Personal Computer in a company's own communication network;
a home communication network application environment, i.e. an application environment in which the PDA 100 is located in the home communication network of the subscriber of a mobile radio communication network; and
   a miscellaneous application environment, i.e. an application environment, which describes all the remaining cases, which have not been covered by the above-mentioned three application environments, for which provision has been made in this case.

In accordance with these embodiments, the following aspects are defined in a security configuration:
Filter rules for permitted data network traffic, more particularly referred to a target computer address on one communication protocol or a plurality of communication protocols to be used or to digital services which are available;
information about the fact whether or not a data synchronization has to be implemented unsecured or via a secure communication connection;
information about the calling-up ability of a computer application for accessing a company's own database for project management; and
the ability to retrieve the game “Tetris”.

In general, it is to be noted that any security-relevant information or a setting within the framework of a communication connection can be defined in a security configuration.

In the examples shown, a configuration consists of a number of rules, which are given in pseudo code. A security configuration 105, 106, 107 can in an alternate embodiment be defined via a graphical user interface, via a database (registry) or in general via any other configuration mechanisms and be stored in the fourth memory or in the fourth memory area of the PDA 100.

Below, the four security configurations provided are shown in pseudo code.

[Company-Wireless]
ALLOW-NETWORK = ANY
PROHIBIT-PROGRAMS = c:\Programme\FallendeKlötzchen [c:\Programs\Tetris]
ALLOW-PROGRAMS = ANY
ALLOW-SYNCHRONIZATION = SECURED
[Company-DirectPC]
ALLOW-NETWORK = INTERFACE(SERIAL, USB)
PROHIBIT-PROGRAMS = c:\Programme\FallendeKlötzchen [c:\Programs\Tetris]
ALLOW-PROGRAMS = ANY
ALLOW-SYNCHRONIZATION = ANY
[Home]
ALLOW-NETWORK = ANY
PROHIBIT-PROGRAMS = c:\Programme\Projektverwaltung [c:\Programs\Project
Management]
ALLOW-PROGRAMS = ANY
ALLOW-SYNCHRONIZATION = NONE
[Remaining]
ALLOW-NETWORK = SERVICE(HTTP, HTTPS)
USE = Content-Filter
PROHIBIT-PROGRAMS = c:\Programme\Projektverwaltung [c:\Programs\Project
Management]
ALLOW-PROGRAMS = ANY
ALLOW-SYNCHRONIZATION = NONE

In accordance with the security configuration [Company-Wireless] there are no restrictions, i.e. any communication network data traffic is permitted (“ALLOW-NETWORK = ANY”). Except for the program “c:\Programme\FallendeKlötzchen” [c:\Programs\Tetris], any computer programs can be executed by the PDA 100 (“PROHIBIT-PROGRAMS=c:\Programme\FallendeKlötzchen [c:\Programs\Tetris]

and “ALLOW-PROGRAMS=ANY”). A synchronization, i.e. an alignment of the data stored in the PDA 100 (stored addresses, schedules, notices) by means of a synchronization unit, for example, a connected Personal Computer or a synchronization server computer, may only be implemented in a secured manner in accordance with this security configuration (“ALLOW-SYNCHRONIZATION=SECURED”).

The security configuration [Company-DirectPC] distinguishes itself from the security configuration [Company-Wireless] with respect to the first entry “ALLOW-NETWORK=INTERFACE(SERIAL, USB)”. This entry means that a communication network connection in accordance with this security configuration can only be set up via a serial communication interface or via a USB communication interface. This can be meaningful in order to ensure that the communication unit or the PDA 100 does not act as a gateway computer between an internal communication network (Intranet) of a company and an external communication network, which can be achieved via another communication interface, for example via a Wireless-LAN communication interface. By means of this entry, all the communication interfaces except for one serial communication interface possibly contained in the PDA 100 and likewise a USB communication interface possibly contained in a USB communication interface are deactivated. With respect to the synchronization of stored data there are no restrictions (“ALLOW-SYNCHRONIZATION = ANY”) in accordance with this security configuration.

In accordance with the security configuration [Home] there are no restrictions (“ALLOW-NETWORK=ANY”) with respect to the permitted communication network connections. All the computer programs except for the computer program “c:\Programme\Projektverwaltung” [c:\Programs\Project Management] are permitted (“PROHIBIT-PROGRAMS = c:\Programme\ProjektVerwaltung” [c:\Programs\Project Management] and “ALLOW-PROGRAMS = ANY”). A synchronization, i.e. an alignment of the data stored in the PDA 100 with the data in a Personal Computer or with a synchronization server computer, in general with a synchronization unit is not allowed in accordance with this security configuration (“ALLOW-SYNCHRONIZATION = NONE”).

However, in accordance with the security configuration [Remaining] there are severe restrictions with respect to the communication network data traffic. Only the network services HTTP (Hyper Text Transfer Protocol) and HTTPS (Hyper Text Transfer Protocol via Secure Socket Layer (SSL)) are permitted (“ALLOW-NETWORK=SERVICE(HTTP, HTTPS)”). It has imperatively been prescribed to use a “Content-Filter”, which blocks any content which has been loaded and seems to be suspect, i.e. data loaded in the PDA 100 (for example, harmful or potentially harmful World Wide Web contents, which could contain a computer virus, represent a computer worm or could perform other damage functions) (see “USE = Content-Filter”). Any programs except for the computer program “c:\Programme\ProjektVerwaltung” [c:\Programs\Project Management] may be called up (“PROHIBIT-PROGAMS = c:\Programme\ProjektVerwaltung” [c:\Programs\Project Management] and “ALLOW-PROGRAMS=ANY”). In accordance with this security configuration, a synchronization of data is not permitted (“ALLOW-SYNCHRONIZATION=NONE”).

In accordance with the preferred embodiments described above, the security configurations are defined by a user of the PDA 100.

In an embodiment, provision is made for showing on a display unit of the PDA, a user interface with a button, by means of which a change in the activation rules, i.e. a change in a specific security configuration is made possible.

In addition, provision has been made as an alternative for an administrator to define the security configurations once for only the administrator to be able to change the security configurations. A “normal” user of the PDA 100 has no access rights for changing the stored security configurations.

In addition, provision is made for the current security configuration by means of which the PDA 100 is operating a communication connection in each case, and/or the known application environment to be shown visually to the user of the PDA by means of the display unit. In addition, the activation of a security configuration can be held in an event log which is likewise stored in a memory of the PDA 100.

In accordance with the first embodiment, the current application environment of the personal digital assistant is thus identified automatically and an automatic activation of the security configuration allocated to the application environment is likewise implemented in this case.

Rules preferably define the identification of the current application environment. Below, a list of the rules has for example been shown in a pseudo code format.

In the embodiment shown, the rules refer to the communication interface and the characteristics of the used communication (communication network settings), in practice, specifically to the used VPN definition and the identity of a computer connected directly to the PDA 100. In this case, the current application environment 102 is given by the characteristics, which can be requested, i.e. by the information “communication interface” and “communication network setting”. The allocation of an application environment to the specific security configuration has been defined by the specified rules and which have been stored in the allocation table 103. These rules are evaluated by an allocation function, i.e. by a computer program 103 stored in the PDA.

IF interface = WLAN and communication network setting = VPN company THEN

SET Security configuration = Company-Wireless

ELSE IF (communication interface = Serial OR communication interface = USB) AND
Peer = CompanyPC7123 THEN

SET Security configuration = Company-DirectPC

ELSE IF communication interface = WLAN AND communication network setting =
myHomeNetwork THEN

SET Security configuration = Home

ELSE IF (communication interface = Serial OR communication interface = USB) AND
Peer = myHomePC THEN

SET Security configuration = Home

ELSE

SET Security configuration = Remaining.

In this way, the security configuration [Company-Wireless] is to be activated if the PDA 100 is connected to the communication network of the company by means of the Wireless-LAN communication interface “WLAN”. In this case, the communication is secured via a virtual private communication network (VPN company).

On the other hand, the security configuration [Company-DirectPC] is to be activated if the PDA 100 is directly connected to the Personal Computer of the company “CompanyPC7123”.

The security configuration [Home] is to be activated if the PDA 100 is in the home communication network of the user via the Wireless-LAN communication interface “WLAN” or if the PDA is connected directly via the serial communication interface or via the USB communication interface to the home Personal Computer “MyHomePC”.

In all other cases, the security configuration [Remaining] should be activated in accordance with these embodiments.

In the example shown, the rules for identifying the application environment are defined by the user of the communication unit, i.e. the PDA 100.

An alternative embodiment of the invention makes provision for an administrator to define these rules, in which case, these settings cannot be changed by a user of the PDA 100.

An alternative embodiment of the invention, instead of the rules or in addition to the rules which have already been mentioned above, also comprises the current location of the PDA 100. The location is preferably given in specifically defined categories, for example “Own office”, “Company site”, “Home” instead of giving geographical information about the longitude and the latitude. The recording of the location preferably takes place in accordance with the method described in [3].

In the following, three location areas “Own office”, “Company site” and “Home” are specified in accordance with this embodiment. The allocation of one of these location areas to a security configuration takes place by means of rules, for example, in accordance with the rules given in the following pseudo code:

IF current location = Own office, THEN

SET Security configuration = Company-DirectPC

ELSE IF current location = Company site THEN

SET Security configuration = Company-Wireless

ELSE IF current location = Home THEN

SET Security configuration = Home

ELSE

SET Security configuration = REMAINING.

In the case of these rules, the security configuration [Company-DirectPC] would be activated if the communication unit, i.e. in accordance with this embodiment of the invention, PDA 100 were in the user's own office. Should the PDA 100 not be in the user's own office, but on the company site of the particular company, the security configuration [Company-Wireless] is activated. Otherwise, should the PDA 100 be in the home of the user, the security configuration [Home] is activated. In all other cases, the security configuration [Remaining] is activated.

By means of the configuration function 104, after the successful determination of the specific application environment and with that the matching security configuration of the communication unit is configured in accordance with these embodiments of the PDA 100 according to the determined security configuration 105, 106, 107.

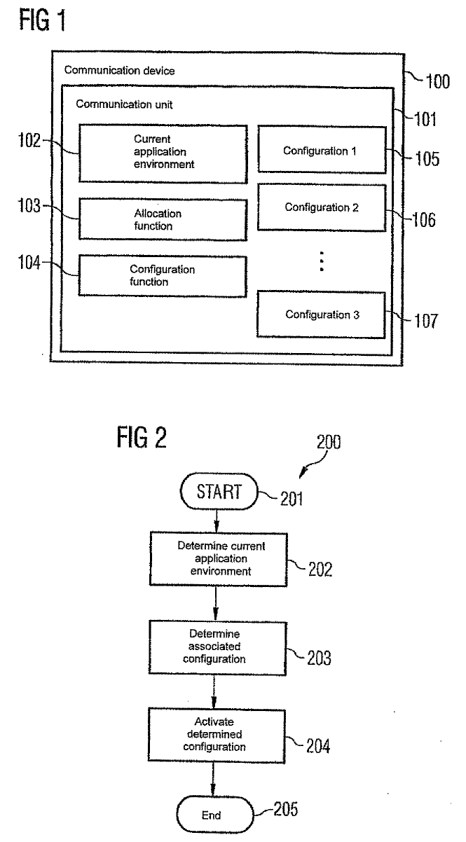

FIG. 2 shows in a flowchart 200, the sequence of the method for determining and configuring the PDA 100.

After Start (step 201) of the method, the PDA 100 determines its current application environment (step 202).

In a subsequent step (step 203), by using the allocation function 103, which is embodied by the microprocessor, the security configuration associated with the current determined application environment is determined.

Subsequently, the associated security configuration determined is activated, i.e. the communication unit is embodied by means of the configuration function 104, whereby the security communication parameters of the PDA 100 are set in accordance with the determined security configuration (step 204).

Following that, the method ends (step 205).

The program sequence shown in the flowchart 200 can be implemented once or also repeatedly by the PDA 100.

The shown method is preferably implemented in the case of a change in the current application environment.

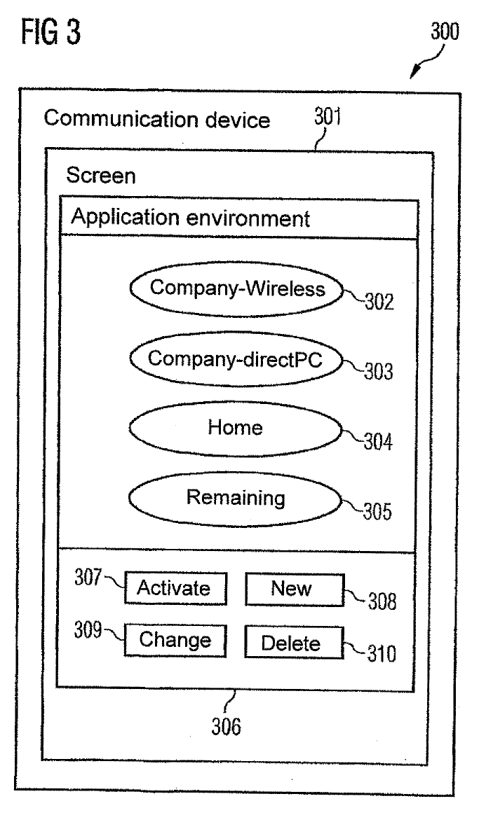

FIG. 3 shows a communication device 300 in accordance with a second embodiment of the invention.

A screen 301 shows a graphic screen surface by means of which a plurality of different application environments is shown for manual selection by the user of the communication unit 300, in accordance with this embodiment, the above-described application environments, namely a first application environment 302 [Company-Wireless], a second application environment 303 [Company-DirectPC], a third application environment 304 [Home] as well as a fourth application environment 305 [Remaining].

In addition, the touch-sensitive screen (touchscreen) 301 shows in another window 306, control buttons 307, 308, 309, 310 from which the users can make their selection in each case.

By selecting the desired application environment 302, 303, 304, 305 and by activating the first button 307 “Activate”, a user of the communication device 300 can activate the security configuration allocated to the selected application environment 302, 303, 304, 305. In this case, there is a 1:1 allocation between the specific application environment and the security configuration allocated to this application environment. This 1:1 allocation is stored in an allocation table 103.

The screen additionally has a second button 308 (“New”) for creating or defining a new application environment, a third button 309 (“Change”) for changing one of the specified application environments or their characteristics as well as a fourth button 310 (“Delete”) for deleting one of the application environments stored and displayed to the user.

The security configurations in accordance with this embodiment correspond to the security configurations according to the above-described embodiment and are, as a result, not explained in greater detail here.

In this context it should be noted that in principle, any security configuration can be defined and provided, in which the security configurations can be implemented by using the customary and known configurations of a “Personal Firewall”. For example, according to the invention it is possible to use well-known host-based packet filters according to the invention under the Linux operating system and other current Unix systems.

The following publications have been cited in this document:

[1] U.S. Pat. No. 6,321,334 BI;
[2] U.S. Pat. No. 6,308,273 Bi;

### [3] WO 01/82562 A2;

### [4] EP 1 139 681 A1;

[5] M. S. Gast, 802.11 Wireless Networks: The Definite Guide, Creating and Administrating Wireless Networks, ISBN 0 596-00183-5, 1^{st} edition, pages 214 to 235, April 2002.

1.-13. (canceled)

14. A communication device, comprising:
a memory that stores a current application environment of the communication device which has been determined based on a location of the communication device;
a communication interface that allows a communication with a further communication device; and
a security configuration memory in which a plurality of different security configurations with regard to the operation of the communication device are stored,
wherein a security configuration is determined from the plurality of security configurations base on the current application environment, and
wherein the device is setup to use the determined security configuration.

15. The communication device according to claim 14, wherein the communication device is a mobile communication device.

16. The communication device according to claim 15, wherein the mobile communication device is embodied as a mobile radiotelephone, a cordless telephone, a personal digital assistant, a pager, a portable computer or combinations thereof.

17. The communication device according to claim 14, wherein the communication interface includes at least one of the interfaces selected from the group consisting of communication interface for the communication with a personal computer, modem communication interface, ISDN adapter communication interface, and LAN adapter communication interface.

18. The communication device according to claim 14, wherein the communication interface is a radio communication interface.

19. The communication device according to claim 18, wherein the radio communication interface includes an interface selected from the group consisting of wireless LAN communication interface, cordless communication interface, and mobile radio communication interface.

20. The communication device according to claim 14, further comprises an allocation table memory that stores an allocation table, in which a security configuration allocated to an application environment is stored in the allocation table.

21. The communication device according to claim 14, further comprises a memory for recording an application environment, which has been set up for the automatic recording and determining of the application environment of the communication device.

22. The communication device according to claim 21, wherein the memory for recording an application environment has been set up for recording one communication method or a plurality of communication methods used by the communication device and/or for recording one security mechanism or a plurality of security measures used by the communication device within the framework of a communication.

23. The communication device according to claim 22, wherein the memory for recording an application environment has been set up for recording one security mechanism or a plurality of security mechanisms used by the communication device within the framework of a communication taking into account at least one security mechanism selected from the group consisting of authentication method, identification information for identifying a communication device or a subscriber, code exchange method for exchanging cryptographic codes, cryptographic code used within the framework of communication; and information elements used within the framework of the communication.

24. The communication device according to claim 21, wherein the memory for recording an application environment is set up to take into account at least one application environment selected from the group consisting of company's own communication network, foreign communication network, home communication network of a user, home communication network of a third party, public communication network; and ad-hoc communication network.

25. The communication device according to claim 14, wherein the security configuration information includes at least one part of the aspects selected from the group consisting of:
information about one communication protocol or a plurality of communication protocols, which can be used by the communication device,
information about one target communication device or a plurality of the target communication devices, which can be reached by the communication device,
information about computer programs or computer program functions, which can be run or called up from the communication device,
information about security methods to be used by the communication device within the framework of the communication,
information about data, which can be accessed by the communication device;
information about the communication methods, which can be used at the same time by the communication device, and
information about the security methods permitted, prohibited and/or required for the communication device.

26. A method for setting a security configuration of a communication device, comprising:
determining an application environment in based on a current location of the communication device;
determining a security configuration associated with the determined application environment from a plurality of different security configurations stored in a security configuration memory of the communication device, each security configuration related to an operation of the communication device; and
setting the communication device in accordance with the determined security configuration.
